(19) United States
(12) Patent Application Publication
(10) Pub. No.: US 2024/0348497 A1
(43) Pub. Date: Oct. 17, 2024

(54) COMBINED EDGE SERVER MANAGEMENT AND SPLIT-RENDERING NEGOTIATION AND SETUP IN 5G

(71) Applicant: TENCENT AMERICA LLC., Palo Alto, CA (US)

(72) Inventor: Iraj SODAGAR, Los Angeles, CA (US)

(73) Assignee: TENCENT AMERICA LLC, Palo Alto, CA (US)

(21) Appl. No.: 18/630,546

(22) Filed: Apr. 9, 2024

Related U.S. Application Data
(60) Provisional application No. 63/458,623, filed on Apr. 11, 2023.
(60) Provisional application No. 63/458,622, filed on Apr. 11, 2023.

(51) Int. Cl. H04L 41/0806; H04L 65/65

(52) U.S. Cl. CPC H04L 41/0806; H04L 65/65

(57) ABSTRACT

A method performed by at least processor in a 5G network for managing an edge server and splitting of one or more media functions of a client of a user equipment (UE), the method includes: determining whether edge provisioning of the edge server is network driven or client driven; determining whether split-rendering provisioning of the edge server and the UE is network driven or client driven; based on a determination (i) the edge provisioning is network driven or (ii) the edge provisioning and the split-rendering provisioning are both client driven, provisioning the edge server; and provisioning a split management session to enable split rendering between the UE and the edge server, wherein the splitting of the one or more media functions of the UE are negotiated with the 5G network after the split management session is provisioned.

### CROSS-REFERENCE TO RELATED APPLICATION

This application claims priority from U.S. Provisional Application No. 63/458,622 filed on Apr. 11, 2023 and from U.S. Provisional Application No. 63/458,623, filed on Apr. 11, 2023, the disclosures of each of which are incorporated herein by reference in their entirety.

### FIELD

The disclosure generally relates to combining edge server management and split-rendering negotiation and setup in 5G networks.

### BACKGROUND

The 3rd Generation Partnership Project (3GPP) defines a work item on split-rendering of media delivery services, in which the client media functions are split between the device and the network edge. Therefore, as a result of the split, the client runs lighter less demanding processes and may receive more complicated applications and services. Furthermore, the edge network decodes and partially renders received media to a simpler form, so that the client may run a lighter process. 5G augmented reality devices need to have intensive processing, including multiple parallel media decoding and media encoding, scene composition, and augmented reality rendering.

3GPP TS26.506 defines an architecture for 5G real-time communication session. While the specification is under development, the current draft defines a brief description of the possibility of using the edge servers in the RTC sessions. 3GPP TS26.506 also defines the general notion of setting up the edge servers by network, however it lacks the method for communication which edge servers are dedicated for the RTC session split-rendering. This invention uses the edge configuration ids to communicate which servers are intended to be used for split-rendering in RTC session

### SUMMARY

According to one or more embodiments, a method performed by at least processor in a 5G network for managing an edge server and splitting of one or more media functions of a client of a user equipment (UE), the method includes: determining whether edge provisioning of the edge server is network driven or client driven; determining whether split-rendering provisioning of the edge server and the UE is network driven or client driven; based on a determination (i) the edge provisioning is network driven or (ii) the edge provisioning and the split-rendering provisioning are both client driven, provisioning the edge server; and provisioning a split management session to enable split rendering between the UE and the edge server, wherein the splitting of the one or more media functions of the UE are negotiated with the 5G network after the split management session is provisioned.

According to one or more embodiments, an apparatus in a 5G network for managing an edge server and splitting of one or more media functions of a client of a user equipment (UE), the apparatus comprising: at least one memory configured to store program code; and at least one processor configured to read the program code and operate as instructed by the program code, the program code including: first determining code configured to cause the at least one processor to determine whether edge provisioning of the edge server is network driven or client driven; second determining code configured to cause the at least one processor to determine whether split-rendering provisioning of the edge server and the UE is network driven or client driven; based on a determination (i) the edge provisioning is network driven or (ii) the edge provisioning and the split-rendering provisioning are both client driven, first provisioning code configured to cause the at least one processor to provision the edge server; and second provisioning code configured to cause the at least one processor to provision a split management session to enable split rendering between the UE and the edge server, wherein the splitting of the one or more media functions of the UE are negotiated with the 5G network after the split management session is provisioned.

According to one or more embodiments, a non-transitory computer readable medium having instructions stored therein, which when executed by a processor of an apparatus in a 5G network for managing an edge server and splitting of one or more media functions of a client of a user equipment (UE), cause the processor to execute a method comprising: determining whether edge provisioning of the edge server is network driven or client driven; determining whether split-rendering provisioning of the edge server and the UE is network driven or client driven; based on a determination (i) the edge provisioning is network driven or (ii) the edge provisioning and the split-rendering provisioning are both client driven, provisioning the edge server; and provisioning a split management session to enable split rendering between the UE and the edge server, wherein the splitting of the one or more media functions of the UE are negotiated with the 5G network after the split management session is provisioned.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1, according to embodiments.

FIG. 3 is a diagram of an architecture of an Augmented Reality (AR) user equipment (UE), according to embodiments.

FIGS. 4A and 4B is a diagram of an architecture of a 5G Standalone EDGe-Dependent AR (5G_STAR EDGAR) UE, according to embodiments.

FIG. 5 is a diagram of a split-rendering architecture, according to embodiments.

FIG. 6 is a diagram of a 5G real-time communication (RTC) architecture, according to embodiments.

FIG. 7 is a diagram of an operation flow of combined edge server management and split-rendering management, according to embodiments.

FIG. 8 is a flow chart of an example process for performing edge server management and split-rendering management, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

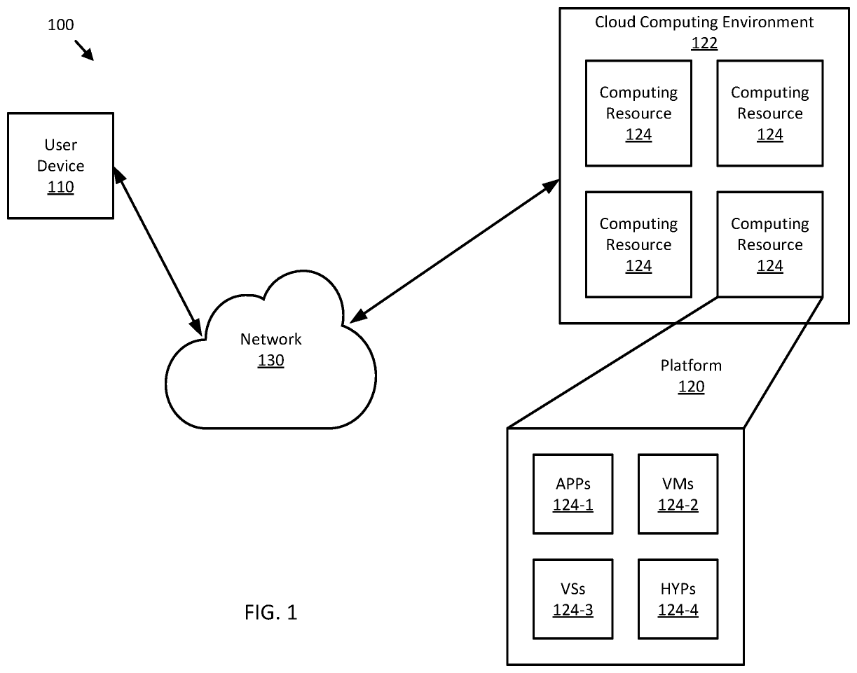

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSs) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

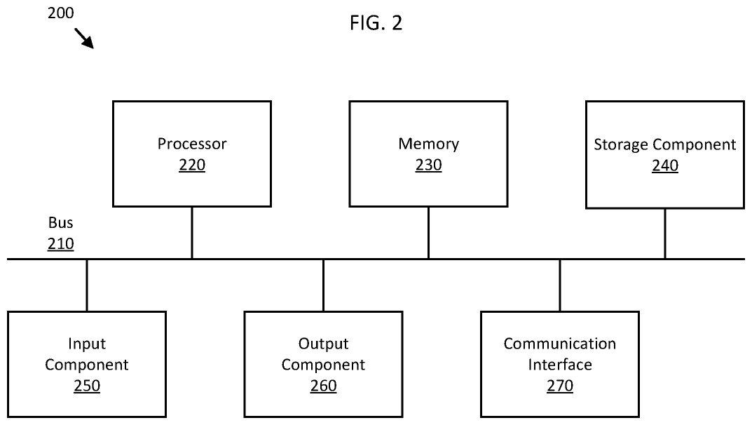

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

A 5G media streaming (5GMS) system may be an assembly of application functions, application servers, and interfaces from the 5G media streaming architecture that support either downlink media streaming services or uplink media streaming services, or both. A 5GMS Application Provider may include a party that interacts with functions of the 5GMS system and supplies a 5GMS Aware Application that interacts with functions of the 5GMS system. The 5GMS Aware Application may refer to an application in the user equipment (UE), provided by the 5GMS Application Provider, that contains the service logic of the 5GMS application service, and interacts with other 5GMS Client and Network functions via the interfaces and application programming interfaces (APIs) defined in the 5GMS architecture. A 5GMS Client may refer to a UE function that is either a 5GMS downlink (5GMSd) Client or a 5GMS uplink (5GMSu) Client, or both.

The 5GMSd Client may refer to a UE function that includes at least a 5G media streaming player and a media session handler for downlink streaming and that may be accessed through well-defined interfaces/APIs. The 5GMSu Client may refer to an originator of a 5GMSu service that may be accessed through well-defined interfaces/APIs. A 5GMSu media streamer may refer to a UE function that enables uplink delivery of streaming media content to an Application Server (AS) function of the 5GMS Application Provider, and which interacts with both the 5GMSu Aware Application for media capture and subsequent streaming, and the Media Session Handler for media session control.

A dynamic policy may refer to a dynamic policy and charging control (PCC) rule for an uplink or downlink application flow during a media session. An egest session may refer to an uplink media streaming session from the 5GMS AS towards the 5GMSu Application Provider. An ingest session may refer to a session to upload the media content to a 5GMSd AS. A policy template may refer to a collection of (semi-static) Policy or Control Function (PCF)/Network Exposure Function (NEF) API parameters which are specific to the 5GMS Application Provider and also the resulting PCC rule. A policy template ID may identify the desired policy template, which is used by the 5GMSd Application Function (AF) to select the appropriate PCF/NEF API towards the 5G system so that the PCF can compile the desired PCC rule. The Media Player Entry may refer to a document or a pointer to a document that defines a media presentation (e.g., a media presentation description (MPD) for DASH or a uniform resource locator (URL) to a video clip file). A Media Streamer Entry may refer to a pointer (e.g., in the form of a URL) that defines an entry point of an uplink media streaming session. A presentation entry may refer to a document or a pointer to a document that defines an application presentation, such as an HTML5 document.

A Provisioning Session may refer to a data structure supplied at an interface (M1d) by a 5GMSd Application provider that configures the 5GMSd features relevant to a set of 5GMSd Aware Applications. A 5GMSd Media Player may refer to a UE function that enables playback and rendering of a media presentation based on a media play entry and exposing some basic controls such as play, pause, seek, stop, to the 5GMSd Aware Application. Server Access Information may refer to a set of parameters and addresses (including 5GMSd AF and 5GMSd AS addresses) which are needed to activate the reception of a streaming session. A Service and Content Discovery may refer to functionality and procedures provided by a 5GMSd Application Provider to a 5GMS Aware Application that enables the end user to discover the available streaming service and content offerings and select a specific service or content item for access. A Service Announcement may refer to procedures conducted between the 5GMS Aware Application and the 5GMS Application Provider such that the 5GMS Aware Application is able to obtain 5GMS Service Access Information, either directly or in the form of a reference to that information.

A third party player may refer to a part of an application that uses APIs to exercise selected 5GMSd functions to play back media content. A third party uplink streamer may refer to a part of an application that uses APIs to exercise selected 5GMSu functions to capture and stream media content.

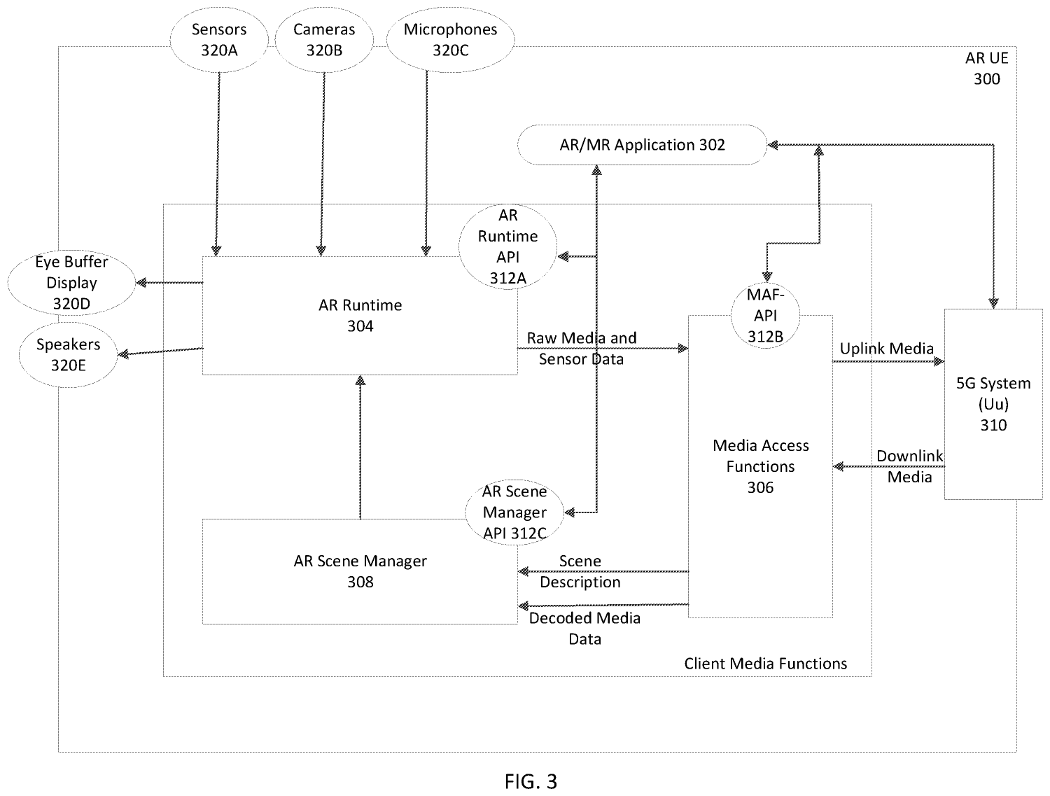

FIG. 3 is a diagram of an architecture of an Augmented Reality (AR) UE 300, according to one or more embodiments. The AR UE 300 may be a 5G UE with 5G connectivity provided through an embedded 5G modem and 5G system components. The AR UE 300 may include several components and user controllers for AR experiences including, but not limited to, sensors 320A, cameras 320B, microphones 320C, eye buffer display 320D, and speakers 320E.

The AR UE 300 may include AR/MR Application 302 that is configured to communicate with various device resources to provide an AR experience to a user. In one or more examples, the AR/MR Application 302 communicates with a AR Runtime 304 via a AR Runtime API 312A, with a Media Access Functions (MAF) via a MAF-API 312B, and a AR Scene Manager 308 via a AR Scene Manager API 312C. These APIs enable the AR/MR Application 302 to discover and query the media capabilities in terms of support as well as available resources at runtime.

In one or more examples, when the AR/MR application 302 is running, the downlink media flows from a 5G System 310 to the MAF 306 in a compressed form, and then from the MAF 306 to the AR Scene Manger 308 in a decoded form. The MAF 306 may further provide a scene description to the AR Scene Manager 308. In one or more examples, in parallel, the AR UE 300 is configured to establish an uplink data flow from the AR Runtime 304 to the MAF 306, where raw media and sensor data may be in an uncompressed form, and then from the MAF 306 to the 5G System 310, where the MAF 306 may have compressed the data in order to facilitate an expected transmission over the network.

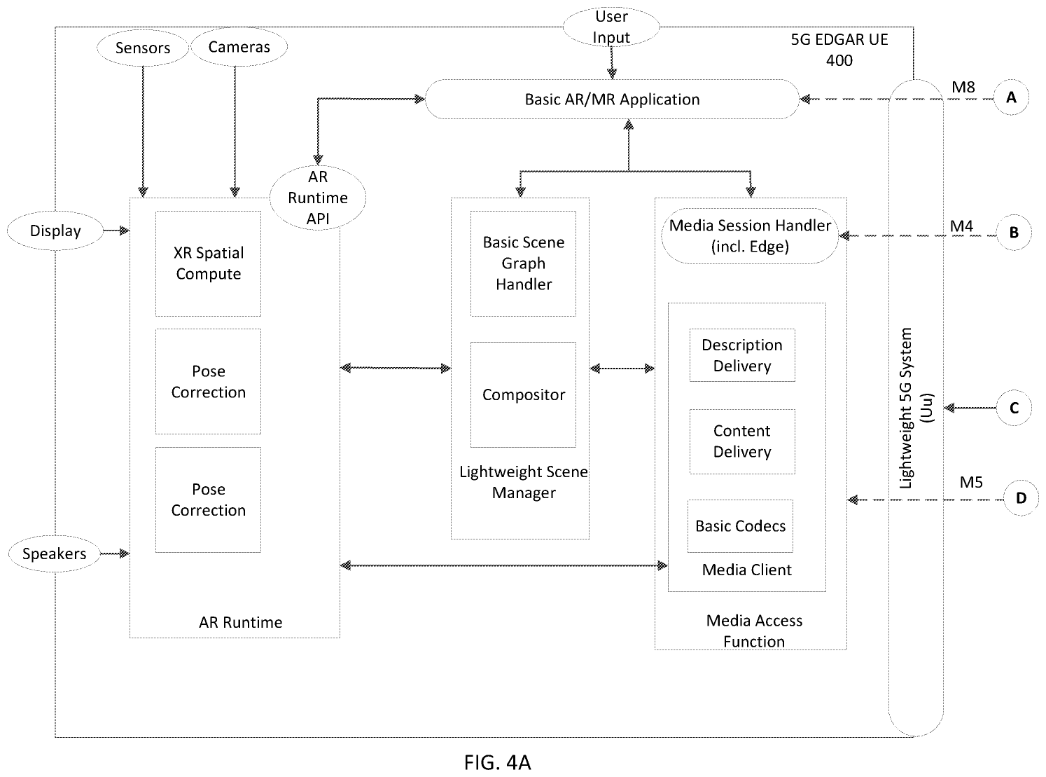

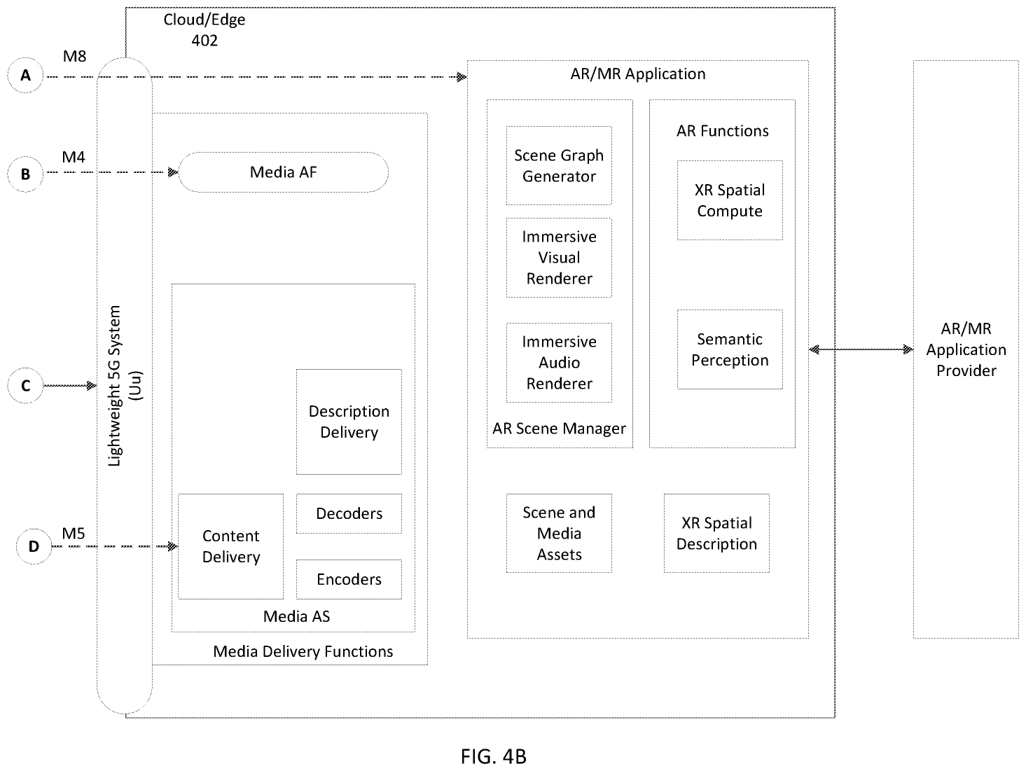

When an Application and/or an Application Service Provider decides to run the client media function in the split-rendering fashion, this functionality is replaced with two new modules: an edge-dependent light media service client, and a media processing application running on 5GMS AS. In one or more examples, a client media function may be an application or one or more tasks to be executed by a client device such as a UE. FIGS. 4A and 4B illustrate an example of a media delivery architecture having a 5G EDGAR UE 400 and a cloud/edge 402 for implementing a split. However, the 3GPP SR_MSE does not specify an architecture or process for performing split-rendering.

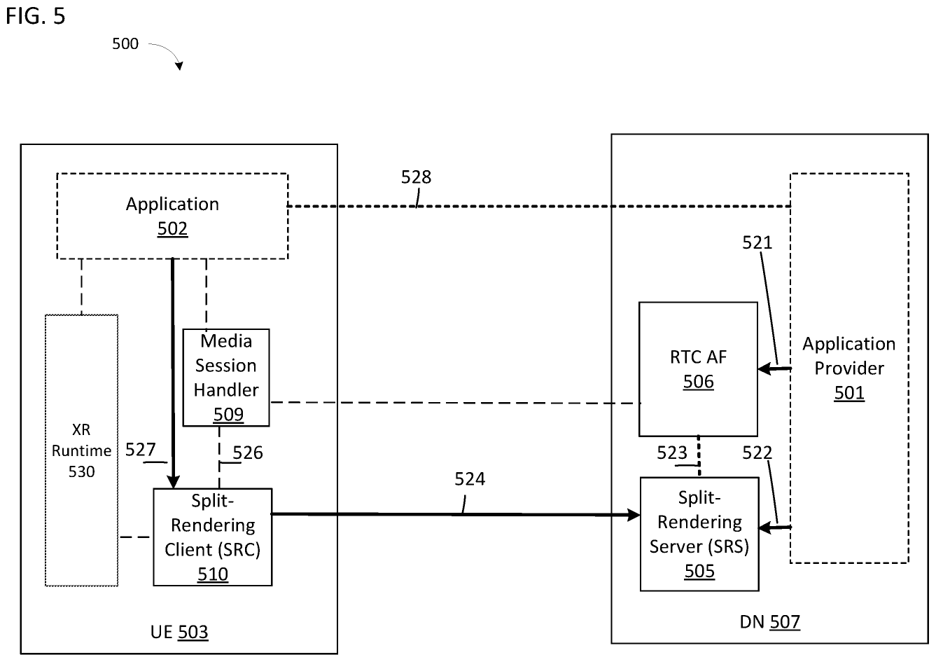

FIG. 5 is a diagram of a 5G end-to-end architecture 500 that comprises a UE 503 and a data network (DN) 507. The architecture 500 may be a 5GMS architecture. The DN 507 includes an Application Provider 501 that may offer a service such as a streaming service. In one or more examples, the streaming service may be a live video streaming session using a social medial platform. The Application Provider 501 may be implemented as a server.

The DN 507 may include a split-rendering server (SRS) 505 responsible for negotiation of a split-rendering session with a split-rendering client, monitoring a server's edge resource usage, and managing/running the split-rendering process. The DN 507 may include a RTC AF 506 responsible for provisioning, QoS allocation, and edge resource discovery.

The UE 503 may include an application 502, which may be an application running on the UE 503. The UE 503 may include a media session handler 509 that communicates with the RTC AF 506 in order to establish, control and support the delivery of a media session. The Media Session Handler 509 may expose APIs that may be used by the application 502.

The UE may include a split-rendering client (SRC) 510 that is responsible to acquire UE media capabilities and negotiated with the SRS 505 to agree on the split-rendering process. The UE may include a XR runtime 530 that may communicate with a 5G-XR application server to get access to XR related data.

The Application Provider 501 provisions the split-rendering through a SR-1 interface 521. The SR-1 interface 521 may be an extension of the M1 interface, which may be a Provisioning API exposed by RTC AF 506 to provision usage of media architecture 500 and to obtain feedback.

In the use cases in which the Application Provider 501 is involved in the media delivery, a SR-2 interface 522 may be used for this purpose. The SR-2 interface 522 may be an extension of a M2 interface, which may be a Publish API exposed by SRS 505.

The communication between the RTC-AF 506 and SRS 505 may be through a SR-3 interface 523. The SR-3 interface may be an extension of the M3 interface, which may be which may be an internal API used to exchange information for content hosting within a trusted DN such as DN 507.

The signaling as well as the media delivery between SRC 510 and SRS 505 may be through a SR-4 interface 524. The SR-4 interface 524 may be an extension of a M4 interface, which may be a Media Streaming API to stream media content.

The RTC AF 506 AF may provide the split-rendering information to the Media Session Handler 506 defined by RTC-5, defined in TS26.506. The SRC 510 in the UE discovers the application through a SR-6 interface 527 and handles the XR runtime 530. The SR-6 interface 527 may be an extension of a M6 interface, which may be a UE 503 Media Session Handling API exposed by Media Session Handler 509 to Application 502.

The SRC 510 may discover the client media capabilities through a SR-7 interface 526. The SR-7 interface may be an extension of a M7 interface, which may be a UE Media Streamer API.

The Application 502 and Application Provider 501 may communicate through a SR-8 528 interface. The SR-8 interface 528 may be an extension of the M8 interface, which may be an Application API used for information exchange between the Application 502 and the Application Provider 501, for example to provide service access information to the Application 502.

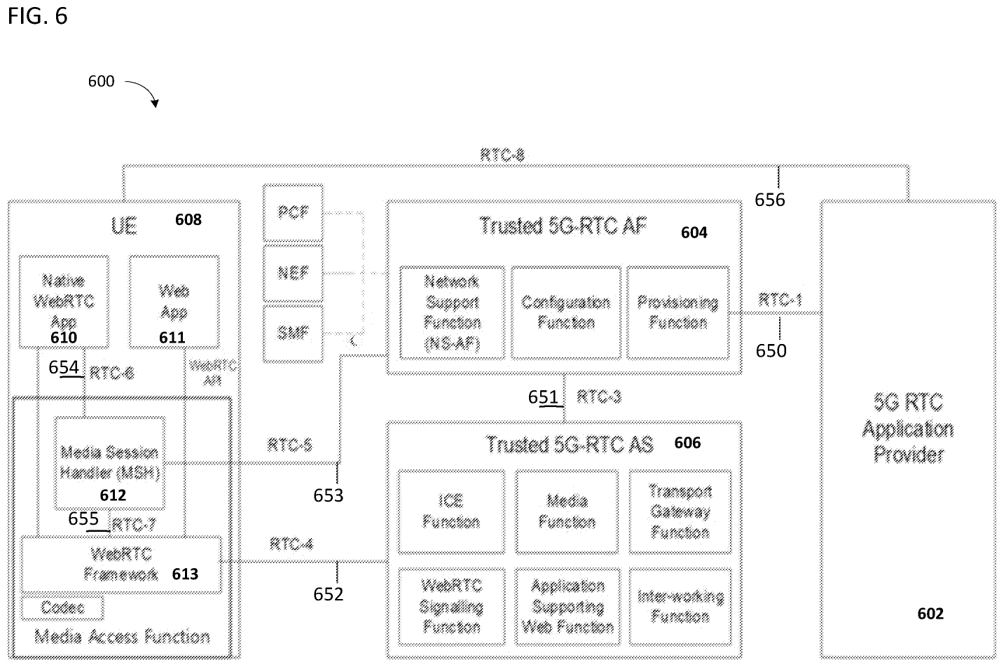

FIG. 6 illustrates an example 5G RTC architecture 600. The RTC architecture 600 may provide the core functions and entities to support WebRTC-based service over a 5G System.

The architecture 600 may include a 5G RTC Application Provider 602, a Trusted 5G RTC AF 604, a Trusted 5G RTC Application Server (AS) 606, and a UE 608.

The Application Provider 602 provides a RTC Aware-Application on the UE to make use of RTC endpoint and network functions using interfaces and APIs. The Trusted 5G RTC

AF 604 may be dedicated to real-time media communication. The functions of the Trusted 5G RTC AF 604 may overlap with the Trusted 5G RTC AF 506. The Trusted 5G RTC AS 606 may be an application server dedicated to real-time media communication.

The UE 608 may include a Native WebRTC App 610, a Web App 611, a Media Session Handler 612, and a WebRTC Framework 613.

The 5G RTC Application Provider 602 may communicate with the Trusted 5G-RTC AF 604 through a RTC-1 interface 650. The RTC-1 interface 650 allows the 5G RTC Application Provider 602 to provision support for RTC sessions that are offered by it. The provisioning may cover the following aspects: QoS support for WebRTC sessions; charging provisioning for WebRTC sessions; collection of consumption and QoE metrics data related to WebRTC sessions; offering ICE functionality such as STUN and TURN servers; offering WebRTC signaling function, potentially with interoperability to other signalling servers.

The Trusted 5G RTC AS 606 may exchange information regarding the RTC session with the Trusted 5G RTC AF 604 over a RTC-3 interface 651. This information may cover QoS flow information and QoS allocation as well as QoE and consumption reports. The 5G Trusted RTC AF 604 may subscribe to information about the status of the QoS flow, which it may share with the Trusted 5G RTC AS 606, e.g., in form of bitrate recommendations.

The Trusted 5G RTC AS 606 may communication with the WebRTC Framework 613 through a RTC-4 interface 652. This interface may be used to exchange the WebRTC traffic with the other endpoint as well as to exchange signaling information related to a WebRTC session with the trusted application servers. The traffic may include media streams sent over RTP, application data sent over data channel, WebRTC Signaling data along with STUN and TURN servers, and any other suitable application data

The RTC-4 interface 652 may further be grouped into two sub-interfaces RTC-4s and RTC-4m as follows. The RTC-4s interface is an interface between the WebRTC framework and the RTC AS such as WebRTC Signaling function. This interface is used for the exchange of signaling information related to the WebRTC session between two or more WebRTC endpoints using trusted application servers. In some cases where the signaling is not handled by WebRTC framework, the RTC-4s interface is an interface between the native WebRTC applications and the WebRTC Signaling server.

The RTC-4m interface is used for transmission of media and other related data between two or more RTC endpoints. The traffic includes media data transmitted over RTP, application data transmitted using Data channel, media related meta-data transmitted using Data channel.

The Trusted 5G RTC AF 604 may communication with the media session handler 612 through a RTC-5 interface. The RTC-5 interface is an interface between the media session handler 612 and the Trusted 5G RTC AF 604. This interface may be used to convey configuration information from the Trusted 5G RTC AF to the media session handler 612 and to request support for a starting/ongoing WebRTC session. The configuration information may include static information such as the following: recommendations for media configurations, configurations of STUN and TURN server locations, configuration about consumption and QoE reporting, discovery information for WebRTC signalling and data channel servers and their capabilities. The support functionality includes the following: receives the configuration information, media session handler 612 informs the Trusted 5G RTC RTC AF 604 about a WebRTC session and its state, media session handler 612 requests QoS allocation for a starting or modified session, media session handler 612 receives notification about changes to the QoS allocation for the ongoing WebRTC session, media session handler 612 receives the updated information about the WebRTC session with the RTC STUN/TURN/Signalling function, e.g. to identify a WebRTC session and associate it with a QoS template.

The Native WebRTC App 610 communicates with the media session handler 612 through a RTC-6 interface 654. The media session handler 612 is a function in the UE 608 that provides access to RTC support functions to the native WebRTC applications. These functions may be offered on request, e.g., through the RTC-6 interface 654, or transparently without direct involvement of the application. The media session handler 612 may assist indirectly in the ICE negotiation by providing a list of STUN and TURN server candidates that offer RTC functionality. The media session handler 612 also collects QoE metric reports and submits consumption reports. It may also offer media configuration recommendations to the application through the RTC-6 interface 654.

The media session handler 612 may communicate with the WebRTC Framework 613 through a RTC-7 interface 655. The RTC-7 interface 655 may be an interface between WebRTC framework and the native WebRTC Application to directly communicate media-specific information.

The 5G RTC Application Provider 602 communicated with the UE 608 through a RTC-8 interface 656. This interface may be used to exchange configuration information related to the RTC session or the application.

The embodiments of the present disclosure combine the edge server management developed in TS 26.501 and the split-rendering negotiation together to employ split-rendering on edge servers.

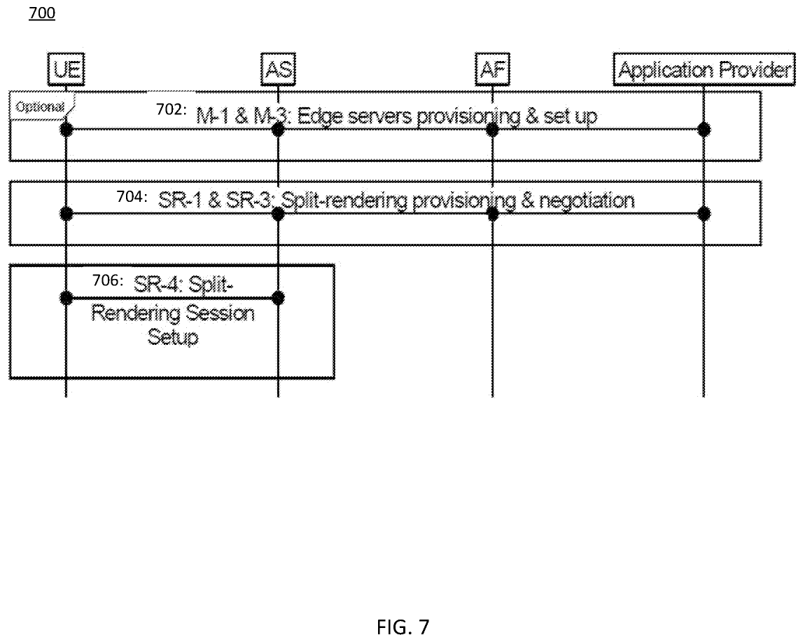

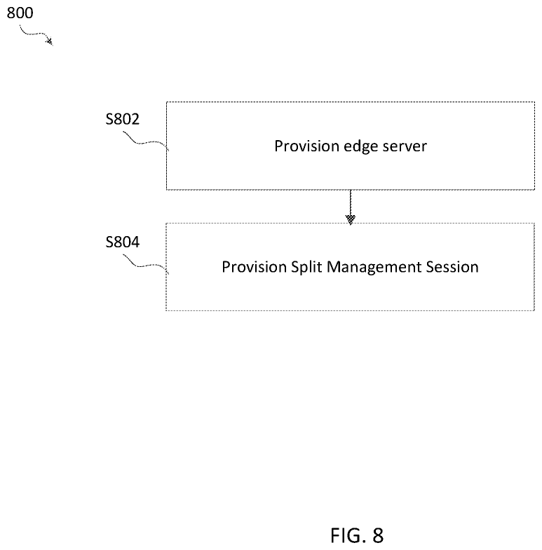

FIG. 7 illustrates an example call flow 700 for combining edge server management with split-rendering negotiation, according to one or more embodiments. The call flow 700 may be implemented using the architecture in FIG. 5 or FIG. 6. For example the UE in FIG. 7 may be UE 503 or UE 608, the AS may be the SRS 505 or the Trusted 5G RTC AS 606, the AF may be the RTC AF 506 or the Trusted 5G RTC AF 604, and the Application Provider may be the Application Provider 501 or the 5G RTC Application Provider 602.

In operation 702, one or more edge servers are provisioned or set up. The Application Provider requests and sets up the edge server(s) used for the split-rendering as follows.

In one or more examples, provisioning may be client-driven. The edge computing provisioning phase is a provisioning phase, that may be repeated several times (e.g. to extend edge processing coverage to new geographical areas or to increase the capacity of an already provisioned area). All operations in this phase are optional and performed on need basis. The operations include, but are not limited to the following:

1. Spawn ECS: In this step, a new ECS is instantiated to manage new or increased demand for edge processing.

2. Spawn 5GMS AF: In this step, a new 5GMS AF that is edge-enabled is instantiated to handle new or increased demand for media sessions with edge processing.

3. EES Configuration: The EES is configured for a specific Edge Data Network.

4. EES Registration with ECS: The EES registers with the ECS that is in authority over the target EDN.

The 5GMS Application Provider Provisioning phase is performed prior to the establishment of any related media streaming sessions by the 5GMS Application Provider. Subsequent updates to the provisioning session are possible.

5. Create Provisioning Session: In this step, the 5GMS Application Provider creates a new provisioning session.

6. Provision 5GMS features: In this step, the 5GMS Application Provider may create different configurations such as Content Hosting, Reporting, Edge Processing, etc.

The 5GMS-Aware Application initiates a new media streaming session:

7. Application Initialization: The user launches the 5GMS-Aware Application. The application performs any required initialization steps.

8. Start session: The 5GMS-Aware Application invokes the Media Streamer with appropriate streaming access parameters.

9. Session starting event: The application informs the Media Session Handler about the start of a new 5GMS session.

10. Retrieve Service Access Information: The Media Session Handler retrieves Service Access Information from the 5GMS AF appropriate to the 5GMS session.

11. Determine eligibility for requesting edge resources: Using information from the Service Access Information, the Media Session Handler determines whether the media streaming session is eligible for requesting edge resources.

If the eligibility criteria are met in the previous step, the UE discovers an EAS instance offering 5GMS AS functionality in the Client-based Edge Computing Discovery phase:

12. Locate candidate “5GMS AS” EAS instances: The Media Session Handler (potentially triggered by a request from the 5GMS-Aware Application) asks its embedded EEC to discover the location of one or more suitable EAS instances offering the “5GMS AS” capability that are able to serve the application.

13. Locate local EES: The EEC queries the ECS for a suitable EES.

14. Register with EES: The EEC registers with the selected EES.

15. Request list of “5GMS AS” EAS instances: The EEC contacts the EES to query for one or more EAS instances offering the “5GMS AS” capability that can serve the session, using EAS discovery filters obtained as a part of the Service Access Information and/or provided by the Application Client, e.g. “5GMS AS” for EAS type, appropriate values for service feature(s), and other EAS characteristics.

The optional sub-flow is for provisioning an additional 5GMS AS instance if a suitable EAS instance offering the “5GMS AS” capability cannot be located. The operations are:

16. Check resource template: The 5GMS AF checks the provisioned edge processing resource template for the related application to determine the edge resource requirements of the application.

17. Instantiate new EAS/5MGS AS: The 5GMS AF requests the MnS to instantiate a new “5GMS AS” EAS instance using the specified requirements in the provisioned edge processing resource template and parameters provided in the query by the EEC.

18. Spawn 5GMS AS instance: The MnS creates a new instance of the EAS offering “5GMS AS” capability with the requested placement and resources.

19. EAS configuration: The newly instantiated “5GMS AS” EAS instance is configured, after which it is discoverable through DNS procedures or the discovery procedures.

20. Register EAS with EES: The newly instantiated EAS instance registers itself with the triggering EES.

21. Configure provisioned features: This may include configuring and launching the server-side application in the 5GMS AS.

Completion of Client-based Edge Computing Discovery phase:

22. List of suitable “5GMS AS” EAS instances: The EES/5GMS AF responds to the EEC with a list of “5GMS AS” EAS instances and their characteristics in an EAS discovery response. Every EAS instance in the list satisfies the requirements defined in the provisioned edge processing resource template.

23. Select preferred “5GMS AS” EAS instance: The AC and/or EEC/Media Session Handler select(s) a “5GMS AS” EAS instance from the provided list, based on the AC's desired criteria.

In the case where the media entry point provided in the Service Access Information includes a host name, the EEC/Media Session Handler inserts a record into the UE's local DNS resolver that resolves this host name to the IP address of the chosen EAS instance.

After the successful discovery of a “5GMS AS” EAS instance, the actual streaming session may start:

24. Media transfer: The 5GMS-Aware Application connects to the selected EAS “5GMS AS” and the streaming starts.

In the case where the media entry point provided in the Service Access Information includes a host name, before connecting, the Media Stream Handler first resolves this to the IP address of the EAS instance selected in operation 23.

25. Method calls and notifications: Supporting information about the 5GMS session is passed from the Media Stream Handler to the Media Session Handler.

26. Reporting, network assistance, and dynamic policy: The Media Session Handler exchanges supporting information about the 5GMS session with the 5GMS AF.

27. End session: the 5GMS-Aware Application informs the Media Session Handler that the 5GMS session has ended.

28. Session ending event: The Media Streamer informs the Media Session Handler about the end of the 5GMS session.

29. Final reporting: The Media Session Handler performs any final reporting to the 5GMS AF.

The Application provider may use any other method to allocation edge servers, or leave it to a mobile network operator (MNO) to set up appropriate edge servers to run the split-rendering process.

In one or more examples, provisioning may be network-driven. The edge computing provisioning phase is a provisioning phase, that may be repeated several times (e.g. to extend edge processing coverage to new geographical areas or to increase the capacity of an already provisioned area). All operations in this phase are optional and performed on need basis. Operations 1-4 may be repeated as described above.

The 5GMS Application Provider Provisioning phase is performed prior to the establishment of any related media streaming sessions by the 5GMS Application Provider. Subsequent updates to the provisioning session are possible. Operations 5 and 6 may be repeated as described above.

The optional sub-flow to provision an additional 5GMS AS instance may be repeated multiple times on need basis to add new capacity, to increase existing capacity for edge processing or to reallocate underused edge processing resources to other tasks. The edge processing capacity is tailored for the specific 5GMS Application Provider based on the information in the Provisioning Session. Operations 7-12 may be repeated as described above above with the following exception:
In operation 7, based on the eligibility criteria in the edge resource template, the 5GMS AF shall determine whether the media streaming session is eligible to use edge resources.

After successful discovery, the actual streaming session may start in the 5GMS Session phase. Operations 13-15 may be repeated as described above, and operations 16-21 may be repeated as described above.

In this procedure, the Application Client (AC) and EEC are not used to discover the 5GMS AS location. Instead, a Media Player Entry may be provided to the Media Session Handler by the 5GMS AF in the Service Access Information at M5 (operation 15), or otherwise the location of the 5GMS AS is provided directly to the 5GMS-Aware Application via (out of scope) interface M8.

Operation 702 may be client-initiated or network-initiated. Operation 702 may be performed using the M1 and M3 interfaces. In one or more examples, operation 702 may include determining whether edge provisioning of the edge server is network driven or client driven.

Edge server provisioning may be repeated several times (e.g. to extend edge processing coverage to new geographical areas or to increase the capacity of an already provisioned area). All steps in this phase are optional and performed on a need basis.

In operation 704, the Application Provider provisions the split-rendering session using SR-1 and SR-3, as defined in the following operations.

The following operations may be performed for edge serve and split-rendering session setup.

1. In this optional operation, the Application Provider requests and sets up the edge server(s) used for the split-rendering. The Application provider may use any other method to allocation edge servers, or leave it to the MNO to set up appropriate edge servers to run the split-rendering process.

2. The Application Provider provisions the split-rendering session using SR-1 and SR-3. If the edge servers were provisioned in operation 1, the edge servers ids are provided in this session to employ them for split-rendering.

In the case of the client-driven edge management, only the client-driven split-rendering is applicable.

3. The split-rendering session is set up.

The client-driven procedures may be performed in accordance with the following operations.

1. The Application Service Provider requests the SRF the provisioning a split management session.

2. The split management session is announced to the Application as part of the Service Access Information.

3. The Application requests a split of the client media functions from the SRC.

4. The SRC inquires the Media Session Handler about the client's media capabilities.

5. The SRC and SRS negotiate on the acceptable capabilities for the device and agree on the split option.

6. The SRS starts the split rendering process.

7. The SRC provides the session information via the RTC-6 interface and requests the application of dynamic policy and subscription to network assistance.

8. The SRC establishes the WebRTC session.

9. The SRC informs the application that the split-rendering on edge is running.

10. The SRC sends uplink metadata, such as pose and action information.

11. The SRS sends the rendered media to the SRC.

If the edge servers were provisioned in operation 702, the edge servers IDs are provided in this session to employ them for split-rendering. Operation 704 may be client-initiated or network-initiated. Operation 704 may be performed using the SR-1 and SR-3 interfaces. In one or more examples, operation 704 may include determining whether split-rendering provisioning fo the edge server and the UE is network driven or client driven.

In operation 706, the split-rendering session is set up. The split-rendering session setup may be in accordance with the following operations.

1. The Presentation Engine discovers the split rendering server and sets up a connection to it. It provides information about its rendering capabilities and the XR runtime configuration, e.g the OpenXR configuration may be used for this purpose.

2. In response, the split rendering server creates a description of the split rendering output and the input it expects to receive from the UE.

3. The Presentation Engine requests the buffer streams from the MAF, which in turn establishes a connection to the split rendering server to stream pose and retrieve split rendering buffers.

4. The Source Manager retrieves pose and user input from the XR runtime.

5. The Source Manager shares the pose predictions and user input actions with the split rendering server.

6. The split rendering server uses that information to render the frame.

7. The rendered frame is encoded and streamed down to the MAF.

In one or more examples, based on a determination (i) the edge provisioning is network driven or (ii) the edge provisioning and the split-rendering provisioning are both client driven, the procedures of provisioning the edge server; and provisioning a split management session to enable split rendering between the UE and the edge server, wherein the splitting of the one or more media functions of the UE are negotiated with the 5G network after the split management session is provisioned are performed.

Referring to the architecture in FIG. 5, the procedure in 700 allows the combinations of client-driven and network-driven edge managements with client-driven and network-driven split rendering negotiation. Table 1 illustrates the different combinations using the architecture in FIG. 5.

TABLE 1

| | | Edge provisioning | |
|---|---|---|---|
| | | Network-driven | Client-driven |
| Split- | Network- | AF provivising for both | Not applicable |
| rendering | driven | | |
| provision- | Client- | The information of edge | The Application |
| ing | driven | servers is provided | provisioning for both. |
| | | through SR-8 or SR-4 | |

The embodiments enable the use of provisioning of edge servers and split-rendering as the sequential provisioning sets through M1 and SR-1 APIs. In one or more examples, the use of TS 26.501 edge provision and management is optional and other methods can be used in this process.

The embodiments of the present disclosure provide the flexible use of the two methods of edge server set up (e.g., client-driven or network-driven) in conjunction with the two methods of split-rendering session setup (e.g., client-driven or network-driven).

In one or more examples, the RTC general provisioning is achieved similar to 5GMS provisioning using CRUD operations, through RTC-1.

In one or more examples, the edge provisioning procedure of 5GMS (TS 26.501) may be used to provision the edge servers through RTC-1. The provisioning may be for client or network driven edge provisioning.

In one or more examples, the split-rendering provisioning procedure of TS26.565 may be used to provision the edge servers through RTC-1. The provisioning may be for client or network driven edge provisioning.

In the case of network-driven edge provisioning, the RTC AF (e.g. Trusted 5G RTC AF 604) may instantiated the required AS/EAS for running split-rendering sessions, obtaining edge server configuration IDs for this provisioning.

In one or more examples, the WebRTC Application may become aware of the deployed edge servers through the Application Service Provider 602 through the RTC-8 interface 656 or through the Media Session Handler 612 through RTC-5 interface 653 (and possibly RTC-6 interface 654) using the edge server configuration IDs.

In one or more examples, the WebRTC Application may request a split-rendering setup on the edge servers identified by edge server configuration id and negotiate the split-rendering session based on its own capabilities as well as the edge server capabilities.

In one or more examples, the edge server provisioning procedure occurs through RTC-1. In this procedure, the edge servers may be requested using AF-driven or client-driven process. In the AF-driven case, the edge-servers are instantiated or identified by the RTC AF (e.g., Trusted 5G RTC AF 604). The Application Service provider (e.g., 5G RTC Application Provider 602) may identify the edge-servers using the edge configuration ID it receives during the provisioning of edge-servers.

In the client-driven case, the client (e.g., UE 608) requests edge servers through its EEC through AF's EES, and receives the list of eligible EAS's.

The split-rendering set up may be client-driven or network-driven.

In the client-driven case for split-rendering set up, the WebRTC application requests the split-rendering session set up. In the case of client-driven edge provisioning, the client (e.g., UE 608) is aware of the allocated EAS's and it can request the split-rendering session to be set up on one of them. In the case of network-driven edge provisioning, the WebRTC Application may become aware of the deployed edge servers through the Application Service Provider (e.g., 5G RTC Application Provider 602) through RTC-8 or through the Media Session Handler through RTC-5 (and possibly RTC-6) using the edge server configuration IDs.

In the network-driven case for split-rendering set up, the split-rendering server (e.g., Trusted 5G-RTC AS 606) requests the split-rendering. In the case of the network-driven edge processing, the RTC AF (e.g., Trusged 5G RTC AF 604) knows which edge server is allocated for the RTC session. It runs the SRS on that edge server and the SRS negotiate with the split-rendering client on the split-rendering session.

Table 2 illustrates the example combinations for edge provisioning and split-rendering set up.

| | | Edge provisioning | |
|---|---|---|---|
| | | Network-driven | Client-driven |
| Split- | Network- | RTC-AF provivising for | Not applicable |
| rendering | driven | both | |
| provision- | Client- | The information of edge | The WebRTC |
| ing | driven | servers is provided | Application |
| | | through RTC-8 or RTC-5 | provisioning for both. |

According to one or more embodiments, A method of cascading the edge server and split-rendering provisionings and set up for allocating the edge servers as well as allowing the WebRTC applications to use the split-rendering functions on the mobile network, where in the client either has both edge server and split-rendering provisioning information if both are client-driven schemes, and therefore it can set up the split-rendering on the dedicated edge server for this purpose, or the edge servers and split-rendering is managed by the MNO and MNO negotiates with the device for split-rendering, and finally the case when the RTC AF intantiates the RTC AS, however the information of the AS is passed to the client either thought Application Servier Provider and Applications, or through RTC-5, where the client has the edge server information and request a split-rendering session on that specific server.

According to one or more embodiments, a procedure of combining the edge server management and split-rendering negotiation and set up wherein the Application Service provider provision edge server management and split-rendering in sequence, wherein the edge server can be initiated as network-driven or client driven, and consequently for the network-driven edge servers, the split-rendering negotiation can be set up in a network-driven or client-driven fashion, wherein in the case of client-driven, information of enabled edge servers are provided to client, wherein in the case of network-driven split-management, the network has the knowledge of the enabled edge servers and runs the split-rendering server on the enabled edge servers.

According to one or more embodiments, a method of cascading the edge server and split-rendering provisioning and set up for allocating the edge servers as well as allowing the WebRTC applications to use the split-rendering functions on the mobile network, where in the client either has both edge server and split-rendering provisioning information if both are client-driven schemes, and therefore it can set up the split-rendering on the dedicated edge server for this purpose, or the edge servers and split-rendering is managed by the MNO and MNO negotiates with the device for split-rendering, and finally the case when the RTC AF instantiates the RTC AS, however the information of the AS is passed to the client either thought Application Service Provider and Applications, or through RTC-5, where the client has the edge server information and request a split-rendering session on that specific server.

What is claimed is:

1. A method performed by at least processor in a 5G network for managing an edge server and splitting of one or more media functions of a client of a user equipment (UE), the method comprising:
determining whether edge provisioning of the edge server is network driven or client driven;
determining whether split-rendering provisioning of the edge server and the UE is network driven or client driven;
based on a determination (i) the edge provisioning is network driven or (ii) the edge provisioning and the split-rendering provisioning are both client driven,
provisioning the edge server; and
provisioning a split management session to enable split rendering between the UE and the edge server, wherein the splitting of the one or more media functions of the UE are negotiated with the 5G network after the split management session is provisioned.

2. The method of claim 1, further comprising:
based on a determination the edge provisioning and the split-rendering provisioning are both network driven, the 5G network comprising a first server operating as a real-time media communication (RTC) application function (AF) and a second server operation as a split-rendering server, provisioning both the edge server and the split-rendering server via RTC AF provisioning.

3. The method of claim 1, further comprising:
based on a determination the edge provisioning and the split-rendering provisioning are both client driven, provisioning both the edge server and the provisioning a split management session via a WebRTC Application provisioning.

4. The method of claim 1, further comprising:
based on a determination the edge provisioning is network driven and the split-rendering provisioning is client driven, providing information of the edge server via one of RTC-8 and RTC-5.

5. The method of claim 1, further comprising:
receiving a request from an Application Provider;
setting up the edge server used for the split-rendering between the edge server and the UE, wherein the edge server set up is performed either by the Application Provider or a mobile network operator to run the split-rendering process.

6. The method of claim 5, further comprising:
provisioning by the Application Provider a split-rendering session using SR-1 and SR-3, wherein the split-rendering session includes an identifier for the edge server previously provisioned.

7. The method of claim 6, further comprising:
establishing the split-rendering session that comprises:
discovering a split-rendering server;
establishing a connection to a split-rendering server;
sending, to the split-rendering server, one or split-rendering capabilities; and
receiving a description of a split-rendering output from the split-rendering server.

8. The method of claim 1, wherein based on a determination the edge provisioning is network-driven and the provisioning of the split management session is client-driven, information associated with the edge server is provided through a SR5 or SR-8 interface.

9. The method of claim 1, wherein based on a determination the edge provisioning and the split-rendering provisioning are both client-driven, the an application service provider communicates with an application of the UE to provision the edge server and provision the split-management session.

10. The method according to claim 1, wherein the 5G network comprises a first server operating as a trusted 5G real-time media communication (RTC) application function (AF) and a second server operating as a trusted 5G RTC application server (AS).

11. An apparatus in a 5G network for managing an edge server and splitting of one or more media functions of a client of a user equipment (UE), the apparatus comprising:
at least one memory configured to store program code; and
at least one processor configured to read the program code and operate as instructed by the program code, the program code including:
first determining code configured to cause the at least one processor to determine whether edge provisioning of the edge server is network driven or client driven;
second determining code configured to cause the at least one processor to determine whether split-rendering provisioning of the edge server and the UE is network driven or client driven;
based on a determination (i) the edge provisioning is network driven or (ii) the edge provisioning and the split-rendering provisioning are both client driven,
first provisioning code configured to cause the at least one processor to provision the edge server; and
second provisioning code configured to cause the at least one processor to provision a split management session to enable split rendering between the UE and the edge server, wherein the splitting of the one or more media functions of the UE are negotiated with the 5G network after the split management session is provisioned.

12. The apparatus of claim 11, wherein the program code further includes:
based on a determination the edge provisioning and the split-rendering provisioning are both network driven, the 5G network comprising a first server operating as a real-time media communication (RTC) application function (AF) and a second server operation as a split-rendering server, third provisioning code configured to cause the at least one processor to provision both the edge server and the split-rendering server via RTC AF provisioning.

13. The apparatus of claim 11, wherein the program code further includes:
based on a determination the edge provisioning and the split-rendering provisioning are both client driven, fourth provisioning code configured to cause the at least one processor to provision both the edge server and the provisioning a split management session via a WebRTC Application provisioning.

14. The apparatus of claim 11, wherein the program code further includes:
based on a determination the edge provisioning is network driven and the split-rendering provisioning is client driven, providing code configured to cause the at least one processor to provide information of the edge server via one of RTC-8 and RTC-5.

15. The apparatus of claim 11, wherein the program code further includes:
receiving code configured to cause the at least one processor to receive a request from an Application Provider;
setting code configured to cause the at least one processor to set up the edge server used for the split-rendering between the edge server and the UE, wherein the edge server set up is performed either by the Application Provider or a mobile network operator to run the split-rendering process.

16. The apparatus of claim 15, wherein the program code further includes:
fifth provisioning code configured to cause the at least one processor to provision by the Application Provider a split-rendering session using SR-1 and SR-3, wherein the split-rendering session includes an identifier for the edge server previously provisioned.

17. The apparatus of claim 16, wherein the program code further includes:
establishing code configured to cause the at least one processor to establish the split-rendering session by causing the at least one processor to:
discover a split-rendering server;
establish a connection to a split-rendering server;
send, to the split-rendering server, one or split-rendering capabilities; and
receive a description of a split-rendering output from the split-rendering server.

18. The apparatus of claim 11, wherein based on a determination the edge provisioning is network-driven and the provisioning of the split management session is client-driven, information associated with the edge server is provided through a SR5 or SR-8 interface.

19. The apparatus of claim 11, wherein based on a determination the edge provisioning and the split-rendering provisioning are both client-driven, the an application service provider communicates with an application of the UE to provision the edge server and provision the split-management session.

20. A non-transitory computer readable medium having instructions stored therein, which when executed by a processor of an apparatus in a 5G network for managing an edge server and splitting of one or more media functions of a client of a user equipment (UE), cause the processor to execute a method comprising:
determining whether edge provisioning of the edge server is network driven or client driven;
determining whether split-rendering provisioning of the edge server and the UE is network driven or client driven;
based on a determination (i) the edge provisioning is network driven or (ii) the edge provisioning and the split-rendering provisioning are both client driven,
provisioning the edge server; and
provisioning a split management session to enable split rendering between the UE and the edge server, wherein the splitting of the one or more media functions of the UE are negotiated with the 5G network after the split management session is provisioned.
